(19) United States
(12) Patent Application Publication
(10) Pub. No.: US 2026/0088987 A1
(43) Pub. Date: Mar. 26, 2026

(54) IMAGE ENCRYPTION CIRCUIT AND METHOD FOR OPERATING THE SAME

(71) Applicant: TAIWAN SEMICONDUCTOR MANUFACTURING COMPANY LTD., HSINCHU (TW)

(72) Inventors: MING-HSIEN YANG, TAICHUNG CITY (TW); CHUN-HAO CHOU, TAINAN CITY (TW); PING-HAO LIN, TAINAN CITY (TW); KUN-HUI LIN, TAINAN CITY (TW); KUO-CHENG LEE, TAINAN CITY (TW)

(21) Appl. No.: 18/895,432

(22) Filed: Sep. 25, 2024

(51) Int. Cl. H04L 9/08; G06F 7/58

(52) U.S. Cl. CPC H04L 9/0869; G06F 7/588

(57) ABSTRACT

The present disclosure provides an integrated circuit, which includes an image sensor, a random number generator circuit, and a processor. The image sensor includes a pixel array configured to generate raw image data detected from incident light of a scene. The random number generator circuit is configured to generate a first key from the raw image data, and generate a second key based on the first key. The processor is configured to encrypt the raw image data by the first key using a first cryptographic algorithm, and encrypt the first key by the second key using a second cryptographic algorithm different from the first cryptographic algorithm.

### BACKGROUND

As technology continues to advance and social media becomes increasingly prevalent, there is a growing concern regarding the potential misuse of artificial intelligence by fraudulent groups. One such concern is the ability to use AI to swap faces and impersonate individuals during video streaming, posing a significant risk for potential fraud. It is imperative to address this issue and implement measures to prevent such fraudulent activities from occurring.

### BRIEF DESCRIPTION OF THE DRAWINGS

Aspects of the present disclosure are best understood from the following detailed description when read with the accompanying figures. It is emphasized that, in accordance with standard practice in the industry, various features are not drawn to scale. In fact, the dimensions of the various features can be arbitrarily increased or reduced for clarity of discussion.

FIG. 1 is a block diagram of a cryptographic system in accordance with an embodiment of the present disclosure.

FIG. 2 is a diagram of an image sensor in accordance with some embodiments of the present disclosure.

FIG. 3 is a block diagram of a random number generator circuit in accordance with some embodiments of the present disclosure.

FIGS. 4A and 4B are diagrams of SR latches in accordance with some embodiments of the present disclosure.

FIG. 5 is a schematic diagram of a pixel circuit in accordance with some embodiments of the present disclosure.

FIGS. 6A to 6E are schematic diagrams illustrating operations of the pixel circuit in FIG. 5.

FIG. 7 is a flowchart of an image encryption process in accordance with some embodiments of the present disclosure.

FIG. 8 is a diagram illustrating a composite variable and its random variable components in accordance with some embodiments of the present disclosure.

FIG. 9 is a flowchart of an image decryption process in accordance with some embodiments of the present disclosure.

FIG. 10 is a flowchart of a method for operating an image encryption circuit in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features can be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “over,” “upper,” “on” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Further, it will be understood that when an element is referred to as being “connected to” or “coupled to” another element, it can be directly connected to or coupled to the other element, or intervening elements can be present.

Embodiments, or examples, illustrated in the drawings are disclosed as follows using specific language. It will nevertheless be understood that the embodiments and examples are not intended to be limiting. Any alterations or modifications in the disclosed embodiments, and any further applications of the principles disclosed in this document are contemplated as would normally occur to one of ordinary skill in the pertinent art.

Further, it is understood that several processing steps and/or features of a device can be only briefly described. Also, additional processing steps and/or features can be added, and certain of the following processing steps and/or features can be removed or changed while still implementing the claims. Thus, it is understood that the following descriptions represent examples only, and are not intended to suggest that one or more steps or features are required.

In addition, the present disclosure may repeat reference numerals and/or letters in the various examples. This repetition is for the purpose of simplicity and clarity and does not in itself dictate a relationship between the various embodiments and/or configurations discussed.

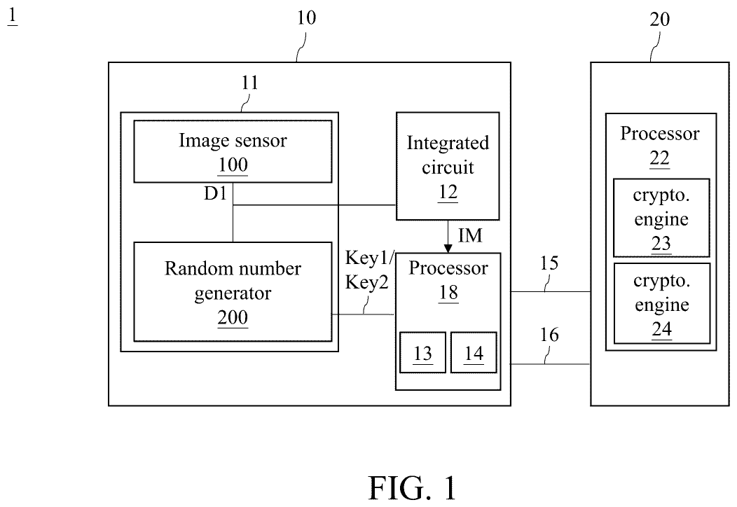

FIG. 1 is a block diagram of a cryptographic system in accordance with an embodiment of the present disclosure.

In some embodiments, the cryptographic system 1 includes a first terminal device 10 and a second terminal device 20. The first terminal device 10 includes an image encryption circuit 11, an integrated circuit 12, and a processor 18, as depicted in FIG. 1. The image encryption circuit 11 may be an application-specific integrated circuit (ASIC) which includes an image sensor 100 and a random number generator circuit 200. In some embodiments, the image sensor 100 may be a color image sensor (CIS) configured to sense an image data signal D1 (e.g., an analog signal) of a color image, where the color image may be an RGB image or RGBW image with a high dynamic range (HDR). In some embodiments, the image sensor 100 and the random number generator circuit 200 may be implemented using separate application-specific integrated circuits.

In some embodiments, the random number generator circuit 200 may be configured to generate a first key (e.g., Key1) and a second key (e.g., Key2) for subsequent encryption in cryptographic engines 13 and 14 within the processor 18. The cryptographic engine 13 is configured to encrypt the color image IM by the first key using a first cryptographic algorithm to generate encrypted image data, while the cryptographic engine 14 is configured to encrypt the first key by the second key using a second cryptographic algorithm. In some embodiments, the integrated circuit 12 may be configured to process the image data signal D1 generated by the image sensor 100 to obtain the color image IM. In some embodiments, the image encryption circuit 11, the integrated circuit 12, and the processor 18 can be encapsulated within the same semiconductor package, such as a system-on-chip (SoC).

In some embodiments, the integrated circuit 12 may transmit the color image IM to the processor 18, and the processor 18 may communicate with the second terminal device 20 through channels 15 and 16, where channels 15 and 16 utilize different wired or wireless communication protocols. For example, the processor 18 of the first terminal device 10 may transmit the encrypted raw image data and an encrypted first key to the second terminal device 20 (e.g., a remote terminal device) through channel 15, where the raw image data and the first key are respectively encrypted by the cryptographic engines 13 and 14 using different cryptographic algorithms. Additionally, the processor 18 may transmit a second key to the second terminal device 20 through channel 16. In some embodiments, the first key and the second key can be derived from the raw image data sensed by the image encryption circuit 11 using respective algorithms, and the details thereof will be described later.

In some embodiments, the second terminal device 20 may be an electronic device or a computer device which includes a processor 22. The second terminal device 20 may receive the encrypted raw image data and an encrypted first key from the first terminal device 10 through channel 15, and receive the second key from the first terminal device 10 through channel 16. The processor 22 may include cryptographic engines 23 and 24. The cryptographic engine 23 is configured decrypt the encrypted raw image data by the first key using the first cryptographic algorithm, and the cryptographic engine 24 is configured to decrypt the encrypted first key by the second key using the second cryptographic algorithm. In some embodiments, the cryptographic engines 13 and 14 in the random number generator circuit 200 is similar to the cryptographic engines 23 and 24 in the processor 22.

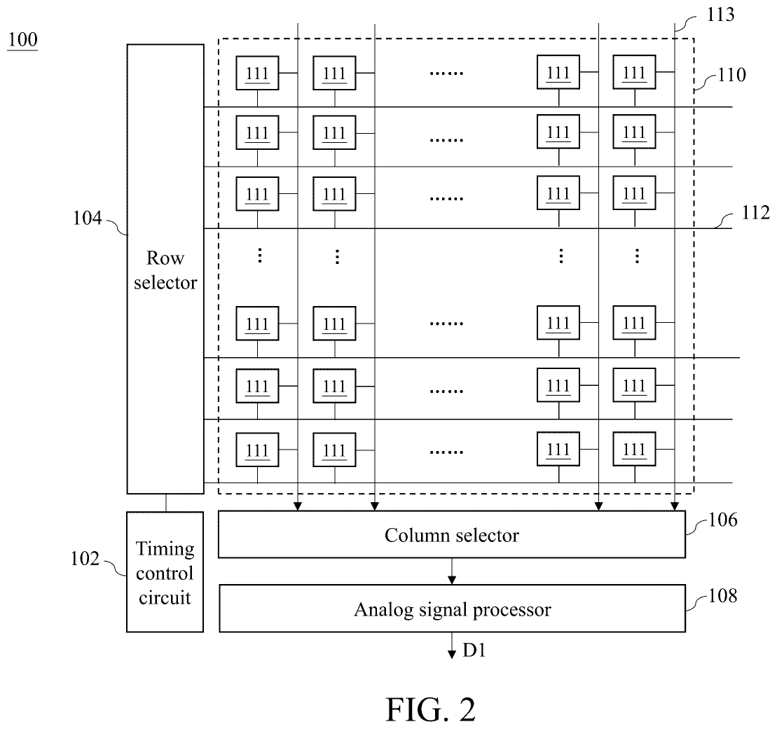

FIG. 2 is a diagram of an image sensor in accordance with some embodiments of the present disclosure.

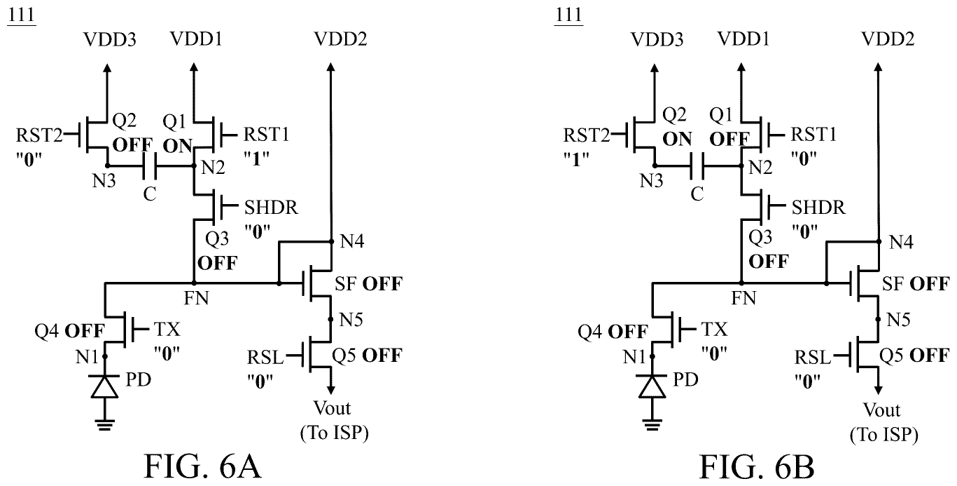

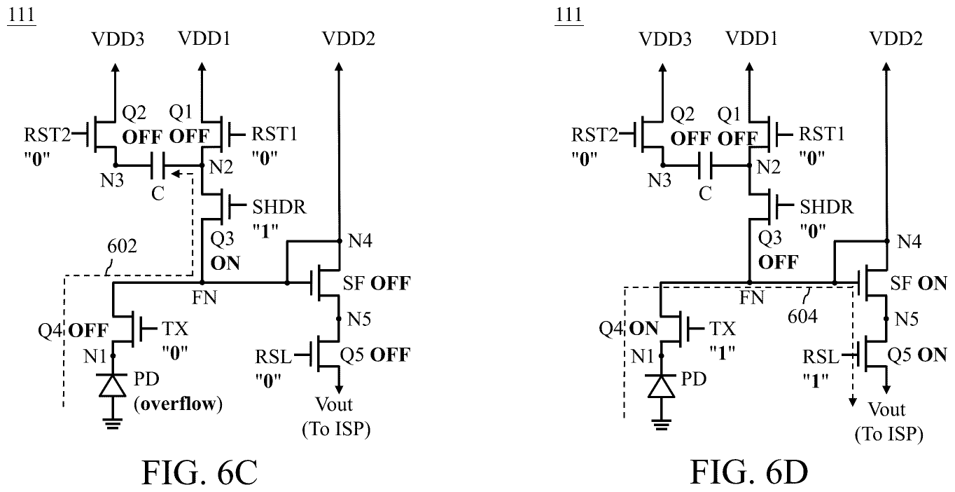

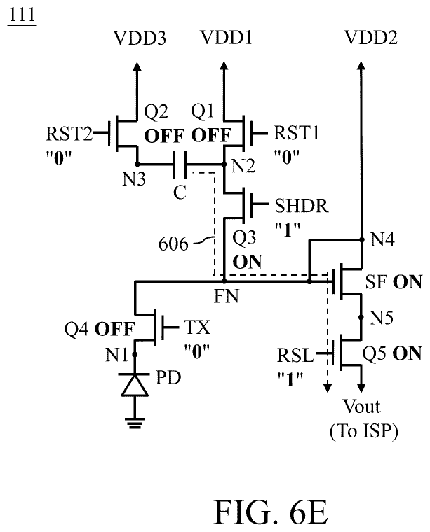

In some embodiments, the image sensor 100 includes a pixel array 110, a timing control circuit 102, a row selector 104, a column selector 106, and an analog signal processor 108. The pixel array 110 may include a plurality of pixel circuits 111 arranged in a two dimensional array with a plurality of row selection lines 112 and a plurality of column selection lines 113. The timing control circuit 102 may control the row selector 104 and the column selector 106 to sequentially select each pixel circuit 111 within the pixel array 110 in a predetermined order, thereby reading out the voltage signal (e.g., an analog signal) sensed by each pixel circuit 111. The analog signal processor 108 may be configured to process the voltage signals read from the pixel circuits 111 to output an HDR analog image data signal D1 (e.g., an analog signal). For example, when reading an HDR voltage signal from each pixel circuit 111, each pixel circuit 111 may output a first voltage signal (e.g., an SDR voltage signal) and a second voltage signal (an overflow voltage signal) at different times, and the analog signal processor 108 may aggregate the first voltage signal and the second voltage signal to generate an HDR voltage signal. More details thereof will be described in the embodiments of FIGS. 6A-6E.

In some embodiments, each of the pixel circuits 111 may be a high-dynamic range pixel circuit capable of convert the amplitude of the electrical signal generated by a photodiode (PD) by detecting the strength of the incident light. In some embodiments, each of the pixel circuits 111 is capable of generating different amplitudes of a color unit including a red subpixel, two green subpixel, and a blue pixel (e.g., arranged in a Bayer pattern) based on the strength of incident light detected by different portions with corresponding color filters of each pixel circuit 111.

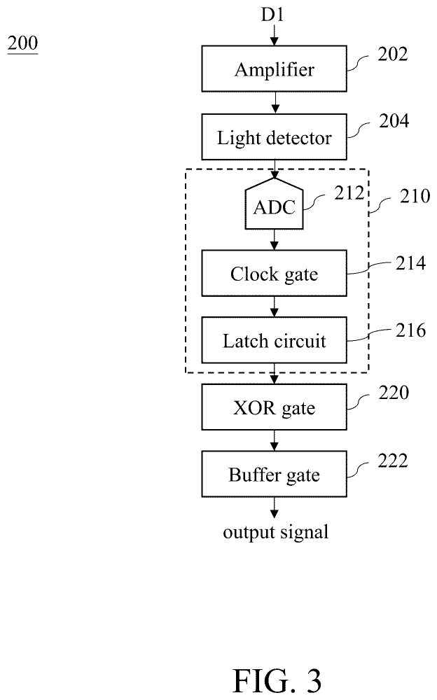

FIG. 3 is a block diagram of a random number generator circuit in accordance with some embodiments of the present disclosure.

In some embodiments, the random number generator circuit 200 includes an amplifier 202, a light detector 204, an analog-to-digital converter 212, a clock gate 214, a latch circuit 216, an XOR gate 220, a buffer gate 222, and an output circuit 230. In some embodiments, the amplifier 202 may be a transimpedance amplifier configured to amplify the analog image data signal D1 generated by the image sensor. For example, the amplifier 202 may be implemented using an operational amplifier (not shown) with a feedback path from its output terminal to its positive input terminal with a feedback capacitor and a feedback resistor (both not shown) arranged in a shunt configuration. For example, the analog image data signal D1 generated by the image sensor 100 may have a relatively low amplitude, and the amplifier 202 can amplify the amplitude of the image data signal D1 (e.g., an analog signal) to a certain level that can be processed by the subsequent circuits.

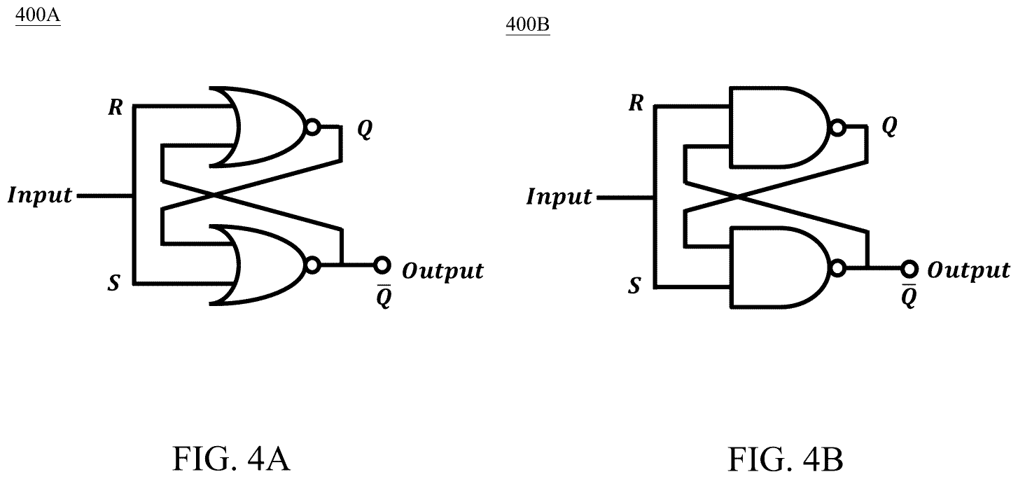

In some embodiments, the light detector (or light selector) 204 may be a first selector stage configured to estimate the amount of the received incident light of the amplified image data signal D1 in units of Db to generate an image detection signal (e.g., an analog signal). The ADC 212, the clock gate 214, and latch circuit 216 may form a second selector stage 210. For example, the ADC 212 may be configured to convert the image detection signal generated by the light detector 204 into a digital image signal, which is fed to the latch circuit 216 through the clock gate 214. The clock gate 214 may be a clock gating circuit operating based on an input clock signal. When the clock signal is in a high-logic state, the digital image signal can pass through the clock gate 214. When the clock signal is in a low logic state, the digital image signal is blocked by the clock gate 214. The latch circuit 216 may include a plurality of SR (set-reset) latch circuits (e.g., 2¹⁶ SR latch circuits for 16-bit pixel values) configured to rearrange the digital image signal in a random manner to generate a randomized digital image signal. Specifically, each SR latch circuit may receive a respective data bit of each pixel in the digital image signal. Each of the SR latch circuits may be two-NOR-gate SR latch 400A or a two-NAND-gate SR latch 400B used to store one bit of information, as shown by FIGS. 4A and 4B, respectively. For example, the input signal of the SR latch 400A and 400B may serve as the set signal S and reset signal R. In some embodiments, the input signal of the SR latch 400A or 400B may serve as an inverse set signal S̅ and an inverse reset signal R̅. Each of the SR latches 400A or 400B can generate a latch output signal with theoretically equal probabilities of 0 and 1 (e.g., each 50%), thereby rearranging the digital image signal in a random manner to generate the randomized digital image signal.

In some embodiments, the randomized digital image signal generated by the latch circuit 216 is fed into XOR gates 220, thereby reducing the impacts of the delay and of logic gates and/or difference in driving capability thereof. As a result, the numbers of 0's and 1's in the output digital image signal generated by the XOR gates 220 become more balanced. Additionally, the output digital image signal generated by the XOR gates 220 is buffered by the buffer gate 222, which is controlled by the clock gate 214. During the active period, the clock gate 214 activates the latch circuit 216 and the buffer gate 222, thereby obtaining an output signal (i.e., a randomized digital signal) from the buffer gate 222. In some embodiments, the output signal generated by the buffer gate 222 may serve as the second key for use in the cryptographic engine 14 in the processor 18.

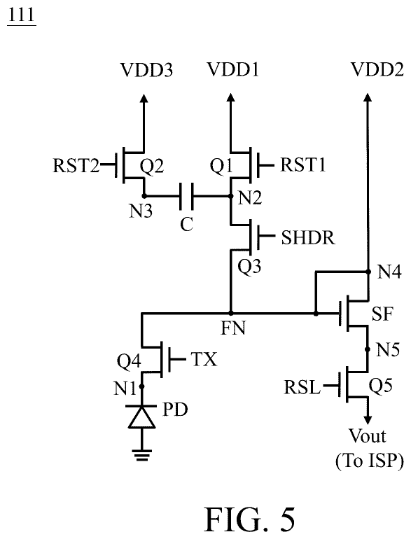

FIG. 5 is a schematic diagram of a pixel circuit in accordance with some embodiments of the present disclosure.

In some embodiments, the pixel circuit 111 may be a high-dynamic range (HDR) complementary metal oxide semiconductor (CMOS) pixel circuit that is integrated into a CMOS image sensor within a stack CIS structure. This structure may include a plurality of dies arranged in the stack CIS structure. The dies may include one or more system-on-chip (SoC) dies and one or more application-specific integrated circuit (ASIC) dies. The pixel circuit 111 may be formed on one of the dies at the top of the stacked structure, but the present disclosure is not limited thereto.

In some embodiments, the pixel circuit 111 may be a 6-transistor (6T) active pixel circuit, which include transistors Q1 to Q5 and SF, a photodetector PD, and a capacitor C, as depicted in FIG. 1. Transistors Q1 to Q5 may be controlled by control signals RST1, RST2, SHDR, TX, and RSL, respectively. For example, the control signal RST1 may be a global reset signal for resetting the CMOS pixel circuit 111. The control signal RST2 may be a reset signal for resetting the capacitor C. The control signal SHDR may be configured to control the pixel circuit 111 to switch between SDR and HDR sensing mode. The control signal TX may be used to control transistor Q4 which may be a transfer gate of the photodetector PD (e.g., a photodiode). The control signal RSL may be used to control transistor Q5 coupled to a read sensing line providing a sensed pixel value of the pixel circuit 111 to an image-signal processor (ISP).

In some embodiments, the capacitor C may be a three-dimensional metal-insulator-metal (3D MIM) lateral overflow integrated capacitor (LOFIC) coupled between nodes N2 and N3, and configured to store electric charges overflowed from the photodetector PD in a high illuminance scene. In some embodiments, the capacitor C may be formed between the topmost metal layer (e.g., TM1) and the second topmost metal layer (e.g., TM2) of the topmost die (e.g., an SoC die) within the stack CIS structure.

In some embodiments, the photodetector PD may include an anode electrically connected to a reference voltage (e.g., a ground voltage) and a cathode electrically connected to node N1. Transistor Q4 may be a transfer gate which includes a first terminal electrically connected to floating node FN and a second terminal electrically connected to node N1. Transistor Q1 may be a global reset switch which includes a first terminal electrically connected to a first power supply voltage VDD1 and a second terminal electrically connected to node N2. Transistor Q2 may be a capacitor-reset switch which includes a first terminal electrically connected to a third power supply voltage VDD3 and a second terminal electrically connected to node N3. Transistor Q3 may be a mode-selection switch which includes a first terminal electrically connected to node N2 and a second terminal electrically connected to floating node FN. Additionally, the first power supply voltage VDD1 is higher than the third power supply voltage VDD3 since the global reset operation may require a higher voltage than the capacitor-reset operation.

In some embodiments, transistor SF may be a source follower transistor which includes a gate electrically connected to floating node FN, a drain electrically connected node N4, and a source electrically connected to node N5. Additionally, transistor SF may be a source follower with the gate and drain of transistor SF being electrically connected. In some embodiments, the gate of transistor SF may not be connected to its drain. Transistor Q5 may be a row-selection switch which includes a first terminal electrically connected to node N5 and a second terminal providing an output voltage Vout of the pixel circuit 111.

FIGS. 6A-6E are diagrams illustrating operations of the pixel circuit shown in FIG. 5.

In some embodiments, before the pixel circuit 111 starts to detect the voltage level corresponding to the illuminance of the incident light of the pixel circuit 111, an initialization procedure may be performed. The initialization procedure may include a global reset operation and a capacitor reset operation. For example, as depicted in FIG. 6A, the control signal RST1 is asserted (e.g., logic “1”) while the remaining control signals RST2, SHDR, TX, and RSL are de-asserted (e.g., logic “0”). At this time, transistor Q1 is turned on, and transistors Q2 to Q5 are turned off. Transistor SF may be turned off since its output path through the source (e.g., node N5) of transistor SF is cut off by transistor Q5. This allows the global reset operation of the pixel circuit 111. It should be noted that some electric charges may be overflowed from photodetector PD to floating node FN through transistor Q4 (e.g., a transfer gate of photodetector PD), and these electric charges will not transferred to the capacitor C through transistor Q3 which is turned off. In some embodiments, a portion of the electric charges stored in the capacitor C may be discharged by the global reset operation.

Upon the global reset operation being completed, the capacitor-reset operation may start. For example, as depicted in FIG. 6B, the control signal RST2 is asserted (e.g., logic “1” while the remaining control signals RST1, SHDR, TX, and RSL are de-asserted (e.g., logic “0”). At this time, transistor Q2 is turned on, and transistors Q1 and Q3 to Q5 are turned off. Transistor SF may be turned off since its output path through the source (e.g., node N5) of transistor SF is cut off by transistor Q5. This allows the capacitor reset operation of the pixel circuit 111, and the electric charges (or the remaining electric charges) stored in the capacitor C may be discharged by the capacitor reset operation.

Upon the capacitor reset operation being completed, the pixel circuit 111 may start to sense the voltage level corresponding to the illuminance of the incident light. For example, as depicted in FIG. 6C, the control signal SHDR is asserted (e.g., logic “1”) while the remaining control signals RST1, RST2, TX, and RSL are de-asserted (e.g., logic “0”). At this time, transistor Q3 is turned on, and transistors Q1, Q2, Q4, and Q5 are turned off. Transistor SF may be turned off since its output path through the source (e.g., node N5) of transistor SF is cut off by transistor Q5. This allows the electric charges, which are overflowed in an overflow current from photodetector PD through transistor Q4, at floating node FN to be stored in the capacitor C through transistor Q3 along path 602 (e.g., a current leakage path).

Subsequently, in response to the capacitor C being fully charged, a first read operation may be performed to read the voltage level detected by the photodetector PD. For example, as depicted in FIG. 6D, the control signals TX and RSL are asserted (e.g., logic “1”) while the remaining control signals RST1, RST2, and SHDR are de-asserted (e.g., logic “0”). At this time, transistor Q4 and Q5 are turned on, and transistors Q1 to Q3 are turned off. Since transistor Q5 is turned on, the output path of transistor SF is conducted, and transistor SF is also turned on. Accordingly, the voltage level detected by the photodetector PD can be transferred to the source of transistor Q5 along path 604 (e.g. a current path) through transistors Q4, SF, and Q5, and the output voltage Vout can be read by the subsequent image-signal processor.

Additionally, after the output voltage Vout of the first read operation being read, a second read operation may be performed to read the voltage associated with the electric charges stored in the capacitor C. For example, as depicted in FIG. 6E, the control signals SHDR and RSL are asserted (e.g., logic “1”) while the remaining control signals RST1, RST2, and TX are de-asserted (e.g., logic “0”). At this time, transistor Q3 and Q5 are turned on, and transistor Q1, Q2, and Q4 are turned off. Since transistor Q5 is turned on, the output path of transistor SF is conducted, and transistor SF is also turned on. Accordingly, the voltage associated with the electric charges stored in the capacitor C can be transferred to the source of transistor Q5 along path 606 (e.g. a current path) from capacitor C through transistors Q3, SF, and Q5, and the output voltage Vout can be read by the subsequent image-signal processor.

It should be noted that the two output voltage Vout read by the subsequent image-signal processor in FIGS. 6D-6E can be used to obtain a high-dynamic range (HDR) pixel value. Additionally, with the technique of the 3D MIM LOFIC, the capacitor C can store more electric charges than existing techniques of integrated capacitors, thereby improving the dynamic range of the output HDR pixel value.

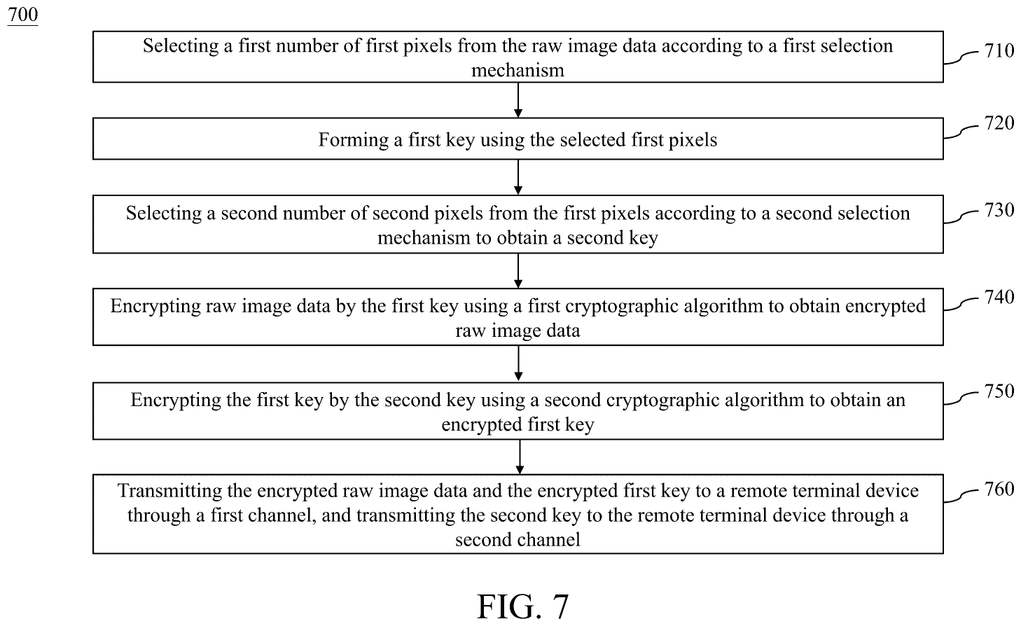

FIG. 7 is a flowchart of a method for operating an image encryption circuit in accordance with some embodiments of the present disclosure.

At operation 710, a first number of first pixels are selected from the raw image data according to a first selection mechanism. In some embodiments, there are several variations of the first selection mechanism. For purposes of description, the pixel array 110 may have 50 million pixel circuits 111 with 1024 rows. Additionally, the pixel array 110 shown in FIG. 2 may have a rectangular resolution (e.g., M rows*N columns), and it can be divided into a left pixel array and a right pixel array, each being a square pixel array (i.e., with the same number of rows and columns). It should be noted that the left pixel array and right pixel array can overlap. In some implementations, 1024 pixels (e.g., M=1024) are selected from the raw image data of the left pixel array and the right pixel array by the random number generator circuit 200 (i.e., total 2048 pixels are selected), respectively. For row 0, the pixels at coordinates (0, 0) and (0, N-1) are selected from the raw image data of the left pixel array and right pixel array, respectively. For row 1, the pixels at coordinates (1, 1), and (1, N-2) are selected from the raw image data of the left pixel array and right pixel array, respectively. For row 2, the pixels at coordinates (2, 2), and (2, N-3) are selected from the raw image data of the left pixel array and right pixel array, respectively, and so on. In other words, the first selection mechanism for selecting first pixels from the raw image data of the left pixel array and the right pixel array is diagonal starting from the upper-left pixel and upper-right pixel within the pixel array 110. Thus, the first pixels selected from the left pixel array are at coordinates (i, i), while the first pixels selected from the right pixel array are at coordinates (i, N-1-i), where i is between 0 and M-1.

In some implementations, the random number generator circuit 200 can select the first pixels from the raw image data in a random manner by the random number generator circuit 200. For example, another random number generator circuit (not shown) can be used select the first pixels from the raw image data.

In some implementations, the random number generator circuit 200 can select the first pixels from the raw image data at locations on an odd row and an odd column, an even row and an even column, an odd row and an even column, or an even row and an odd column. The numbers of odd/even rows and odd/even column can be in ascending order or descending order, depending on the starting location.

In some implementations, the random number generator circuit 200 can select the first pixels from the raw image data at locations corresponding to prime numbers. For example, the raw image data can be treated as a one-dimensional array, and the prime numbers may indicate the addresses of the selected first pixels.

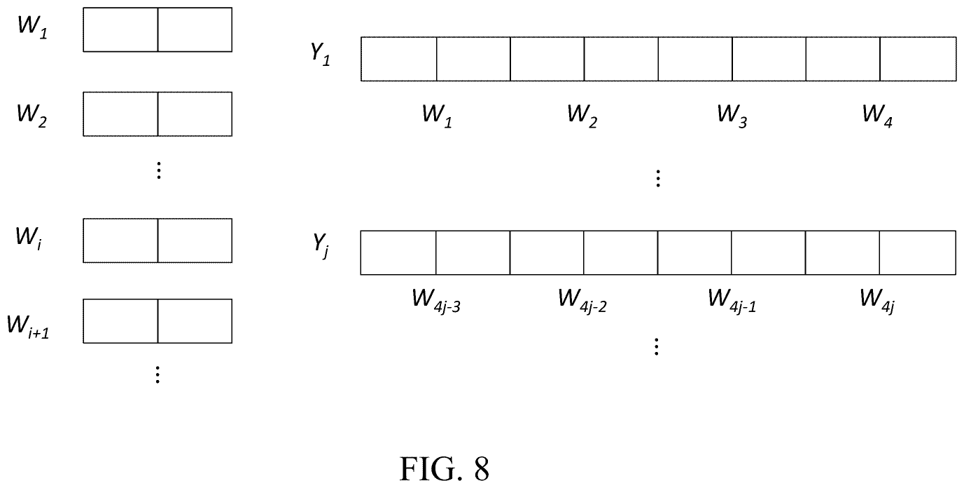

At operation 720, a first key is formed using the selected first pixels. In some embodiments, assuming that the HDR pixel value sensed by each pixel circuit 111 is 16 bit, the selected first pixels can be arranged into a one-dimensional array to form the first key which include a total length of 2048*16=32767 bits. For example, the first 8 bits of the first key is the pixel at coordinates (0, 0), while the second 8 bits of the first key is the pixel at coordinates (0, M-1), and so on. In some embodiments, the selected first pixels can be arranged one by one to form the one-dimensional array. In some embodiments, the one-dimensional array can be obtained by applying a 2-bit data formation technique on the selected first pixels, the details of which will be described in the embodiment of FIG. 8.

At operation 730, a second number of second pixels are selected from the first pixels according to a second selection mechanism to obtain a second key. In some embodiments, the random number generator circuit 200 is configured to select the second number of second pixels from the first pixels in a random manner, the details of which can be referred to the embodiment of FIG. 3.

At operation 740, the raw image data is encrypted by the first key using a first cryptographic algorithm to obtain encrypted raw image data. In some embodiments, the cryptographic engine 13 performed by the processor 18 encrypts the raw image data, which is detected by the image sensor 100, by the first key (e.g., selected from the raw image data according to g the first selection mechanism) using the first cryptographic algorithm to obtain the encrypted raw image data.

At operation 750, the first key is encrypted by the second key using a second cryptographic algorithm to obtain an encrypted first key. In some embodiments, the second key is a randomized version of the second pixels selected from the first pixels according to the second selection mechanism.

At operation 760, the encrypted raw image data and the encrypted first key is transmitted to a remote terminal device through a first channel, and the second key is transmitted to the remote terminal device through a second channel. In some embodiments, the processor 18 transmits the encrypted raw image data and the encrypted first key, which can be collectively regarded as a first data signal, to the second terminal device 20 through channel 15, and transmits the second key, which can be regarded as a second data signal, to the second terminal device 20 through channel 16. Channels 15 and 16 utilize different wired or wireless communication protocols. Additionally, the encrypted raw image data and the encrypted first key employ different cryptographic algorithms. Accordingly, the safety of the image signal during transmission from a local terminal device (e.g., first terminal device 10) to a remote terminal device (e.g., second terminal device 20) can be protected by the method proposed in the present disclosure.

In some embodiments, the processor 18 may perform a least-significant bit (LSB) steganography technique on the raw image data to embed a particular information therein. For example, each pixel of the raw image data includes a red subpixel, a green subpixel, and a blue subpixel, each having a color depth of 16 bits (e.g., HDR pixel). By modified the values of the least two bits of each red subpixel, green subpixel, and blue subpixel, the user cannot perceive the difference between the original raw image data and the modified raw image data, while a particular information (e.g., watermark, trademark, personal information, etc.,) can be embedded in the modified raw image data. Furthermore, the modified raw image data can be treated as the raw image data mentioned in the method 700 shown in FIG. 7.

FIG. 8 is a diagram illustrating a composite variable and its random variable components in accordance with some embodiments of the present disclosure.

In some embodiments, a 2-bit data formation technique can be used to obtain the first key, and the first key includes a plurality of composite data segments. For purposes of description, both the pixel value of each pixel and a composite data segment Y_{J} have a length of 8 bits. Given that Wᵢ is a random variable corresponding to the 2-bit data of the i-th pixel, the composite data segment Y_{J} (e.g., 8-bit data) can be expressed by Y_{J}:=W₄ⱼ₋₃∥W₄ⱼ₋₂∥W₄ⱼ₋₁∥W₄ⱼ, as shown in FIG. 8. For example, given that W₁=(0, 1), W₂=(1, 1), W₃=(0, 0), and W₄=(1, 0), the composite data segment Y₁ can be expressed as Y₁=(0, 1, 1, 1, 0, 0, 1, 0). For example, a 8-bit pixel value can be divided into four 2-bit data segments, and one of the 2-bit data segments is selected sequentially. Thus, four 2-bit data segments, each obtained from a respective 8-bit pixel value (e.g., first pixels selected from the raw image data), can form a 8-bit composite data segment. Accordingly, the first pixels can be arranged into a one-dimensional array using the 2-bit data formation technique to generate the first key.

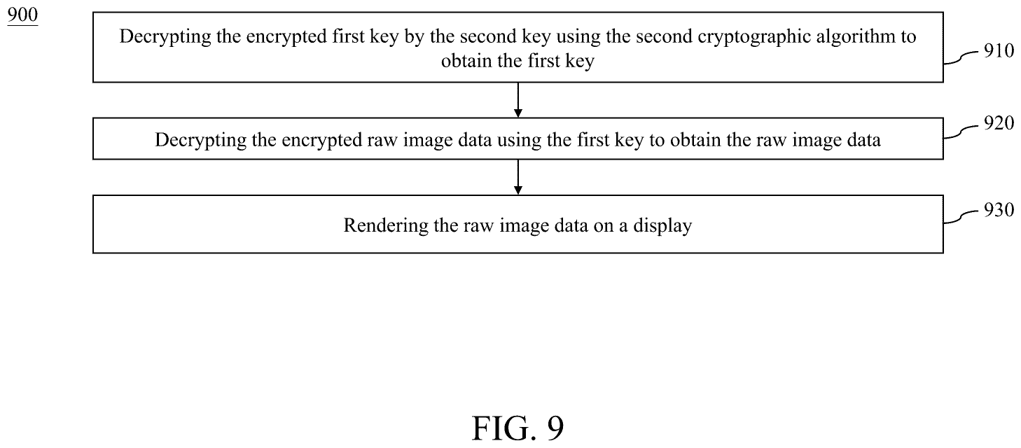

FIG. 9 is a flowchart of an image decryption process in accordance with some embodiments of the present disclosure.

At operation 910, the encrypted first key is decrypted by the second key using the second cryptographic algorithm to obtain the first key. In some embodiments, the decryption flow performed by the second terminal device 20 may be inverse to the encryption flow performed by the first terminal device 10. Thus, the cryptographic engine 24 performed by the processor 22 decrypts the encrypted first key by the second key using the second cryptographic algorithm to obtain the first key.

At operation 920, the encrypted raw image data is decrypted by the first key to obtain the raw image data. In some embodiments, the cryptographic engine 23 performed by the processor 22 decrypts the encrypted raw image data by the first key using the first cryptographic algorithm to obtain the raw image data.

At operation 930, the raw image data is rendered on a display. For example, once the processor 22 of the second terminal device 20 obtains the raw image data through the decryption operations 910 and 920, the processor 22 may rendered the raw image data on a display, thereby achieving secure real-time video streaming. More specifically, when the processor 22 of the second terminal device 20 finds that there are occurrences of errors while decrypting the encrypted raw image data, the processor 22 can determine that the transmission of the encrypted raw image data or the encrypted first data has been tampered, and the image data received from the first terminal device 10 can be discarded.

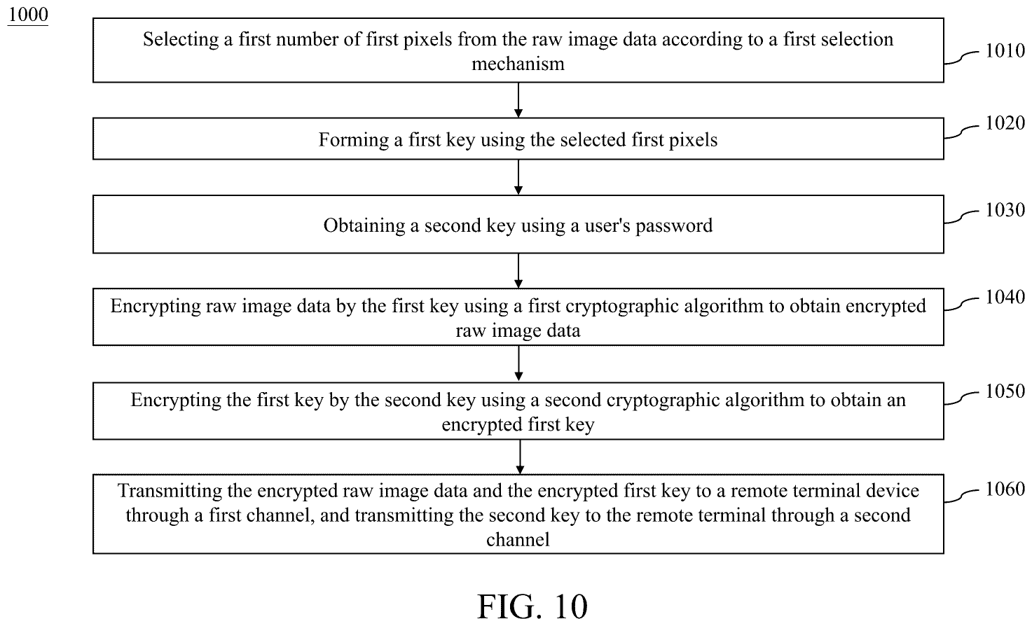

FIG. 10 is a flowchart of a method for operating an image encryption circuit in accordance with some embodiments of the present disclosure.

In some embodiments, operations 1010 to 1060 in method 1000 shown in FIG. 10 may be similar to operations 710 to 760 in method 700 shown in FIG. 7, with the difference being that the second key is obtained using a user's password in operation 1030. For example, the user can register the user's password at the first terminal device 10 and the second terminal device 20 in advance. Accordingly, the first terminal device 10 and the second terminal device 20 can use the registered user's password as the second key during the encryption/decryption procedure.

An aspect of the present disclosure provides an integrated circuit, which includes an image sensor, a random number generator circuit, and a processor. The image sensor includes a pixel array configured to generate raw image data detected from incident light of a scene. The random number generator circuit is configured to generate a first key from the raw image data, and generate a second key based on the first key. The processor is configured to encrypt the raw image data by the first key using a first cryptographic algorithm, and encrypt the first key by the second key using a second cryptographic algorithm different from the first cryptographic algorithm.

Another aspect of the present disclosure provides an integrated circuit, which includes an image sensor, a random number generator circuit, and a processor. The image sensor includes a pixel array configured to generate raw image data detected from incident light of a scene. The random number generator circuit is configured to generate a first key from the raw image data, and obtain a second key based on a preset password. The processor is configured to encrypt the raw image data by the first key using a first cryptographic algorithm, and encrypt the first key by the second key using a second cryptographic algorithm different from the first cryptographic algorithm.

Yet another aspect of the present disclosure provides a method for operating an image encryption circuit. The image encryption circuit comprises an image sensor and a random number generator circuit. The method includes the following steps: utilizing the random number generator circuit to select a first number of first pixels from raw image data detected by the image sensor according to a first selection mechanism; utilizing the random number generator circuit to form a first key using the selected first pixels; utilizing the random number generator circuit to select a second number of second pixels from the first pixels according to a second selection mechanism to obtain a second key; encrypting raw image data by the first key using a first cryptographic algorithm to obtain encrypted raw image data; encrypting the first key by the second key using a second cryptographic algorithm to obtain an encrypted first key, wherein the second cryptographic algorithm is different from the first cryptographic algorithm; and transmitting the encrypted raw image data and the encrypted first key to a remote terminal device through a first channel, and transmitting the second key to the remote terminal device through a second channel.

The methods and features of the present disclosure have been sufficiently described in the provided examples and descriptions. It should be understood that any modifications or changes without departing from the spirit of the present disclosure are intended to be covered in the protection scope of the present disclosure.

Moreover, the scope of the present application is not intended to be limited to the particular embodiments of the process, machine, manufacture, and composition of matter, means, methods and steps described in the specification. As those skilled in the art will readily appreciate from the present disclosure, processes, machines, manufacture, composition of matter, means, methods or steps presently existing or later to be developed, that perform substantially the same function or achieve substantially the same result as the corresponding embodiments described herein, can be utilized according to the present disclosure.

Accordingly, the appended claims are intended to include within their scope processes, machines, manufacture, compositions of matter, means, methods or steps. In addition, each claim constitutes a separate embodiment, and the combination of various claims and embodiments are within the scope of the present disclosure.

What is claimed is:

1. An integrated circuit, comprising:
an image sensor, comprising a pixel array configured to generate raw image data detected from incident light of a scene;
a random number generator circuit, configured to generate a first key from the raw image data, and generate a second key based on the first key; and
a processor, configured to encrypt the raw image data by the first key using a first cryptographic algorithm, and encrypt the first key by the second key using a second cryptographic algorithm different from the first cryptographic algorithm.

2. The integrated circuit of claim 1, wherein the random number generator circuit selects a plurality of first pixel from the raw image data according to a first selection mechanism, and forms the first key using the selected first pixels.

3. The integrated circuit of claim 2, wherein the random number generator circuit selects a plurality of second pixels from the first pixels according to g a second selection mechanism different from the first selection mechanism to obtain the second key.

4. The integrated circuit of claim 1, wherein the random number generator circuit comprises:
an amplifier, configured to amplify an image data signal generated by the image sensor; and
a light detector, configured to estimate an amount of received incident light of the amplified data signal to generate an image detection signal.

5. The integrated circuit of claim 4, wherein the random number generator circuit further comprises:
an analog-to-digital converter (ADC), configured to convert the image detection signal into a digital image signal;
a clock gate, configured to provide an activation signal; and
a latch circuit, comprising a plurality of latches, each receiving a data bit of each pixel in the digital image signal.

6. The integrated circuit of claim 5, wherein the plurality of latches are SR (set-reset) latches.

7. The integrated circuit of claim 5, wherein the random number generator circuit further comprises:
a plurality of exclusive-OR (XOR) gates, each configured to receive a latch output signal generated by the respective latch to generate an output digital image signal; and
a buffer gate, configured to buffer the output digital image signal.

8. The integrated circuit of claim 7, wherein the latch circuit and the buffer gate are controlled by the activation signal generate by the clock gate.

9. The integrated circuit of claim 1, wherein:
the processor transmits a first data signal and a second data signal to a remote terminal device through a first channel and a second channel different from the first channel, respectively;
the first data signal comprises the encrypted raw image data and the encrypted first key;
the second data signal comprises the second key; and
a communication protocol utilized by the first channel is different from that utilized by the second channel.

10. The integrated circuit of claim 9, wherein the remote terminal device decrypts the encrypted first key by the second key received from the integrated circuit using the second cryptographic algorithm to obtain the first key, and decrypts the encrypted raw image data by the first key using the first cryptographic algorithm to obtain the raw image data.

11. The integrated circuit of claim 2, wherein the pixel array comprises a first pixel array and a second pixel array, and the random number generator circuit performs the first selection mechanism to select the plurality of first pixels from the raw image data corresponding to the first pixel array and the second pixel array in a first diagonal direction and a second diagonal direction, respectively.

12. The integrated circuit of claim 2, wherein the random number generator circuit performs the first selection mechanism to select the plurality of first pixels from the raw image data in a random manner.

13. The integrated circuit of claim 2, wherein t the random number generator circuit performs the first selection mechanism to select the plurality of first pixels from the raw image data at positions on an even row and an even column, an even row and an odd column, an odd row and an even column, or an odd row and an odd column of the pixel array.

14. An integrated circuit, comprising:
an image sensor, comprising a pixel array configured to generate raw image data detected from incident light of a scene;
a random number generator circuit, configured to generate a first key from the raw image data, and obtain a second key based on a preset password; and
a processor, configured to encrypt the raw image data by the first key using a first cryptographic algorithm, and encrypt the first key by the second key using a second cryptographic algorithm different from the first cryptographic algorithm.

15. The integrated circuit of claim 14, wherein the random number generator circuit selects a plurality of first pixel from the raw image data according to a first selection mechanism, and forms the first key using the selected first pixels.

16. The integrated circuit of claim 15, wherein the random number generator circuit selects a plurality of second pixels from the first pixels according to a second selection mechanism different from the first selection mechanism to obtain the second key.

17. The integrated circuit of claim 16, wherein:
the processor transmits a first data signal and a second data signal to a remote terminal device through a first channel and a second channel different from the first channel, respectively;
the first data signal comprises the encrypted raw image data and the encrypted first key;
the second data signal comprises the second key; and
a communication protocol utilized by the first channel is different from that utilized by the second channel.

18. The integrated circuit of claim 15, wherein the random number generator circuit forms the first key by applying a 2-bit data formation technique on the selected first pixels.

19. A method for operating an image encryption circuit, wherein the image encryption circuit comprises an image sensor and a random number generator circuit, the method comprising:
utilizing the random number generator circuit to select a first number of first pixels from raw image data detected by the image sensor according to a first selection mechanism;
utilizing the random number generator circuit to form a first key using the selected first pixels;
utilizing the random number generator circuit to select a second number of second pixels from the first pixels according to a second selection mechanism to obtain a second key;
encrypting raw image data by the first key using a first cryptographic algorithm to obtain encrypted raw image data;
encrypting the first key by the second key using a second cryptographic algorithm to obtain an encrypted first key, wherein the second cryptographic algorithm is different from the first cryptographic algorithm; and
transmitting the encrypted raw image data and the encrypted first key to a remote terminal device through a first channel, and transmitting the second key to the remote terminal device through a second channel.

20. The method of claim 19, further comprising:
decrypting, at the remote terminal device, the encrypted first key by the second key received from the image encryption circuit using the second cryptographic algorithm to obtain the first key; and
decrypting, at the remote terminal device, the encrypted raw image data by the first key using the first cryptographic algorithm to obtain the raw image data.
